(19) United States
(12) Patent Application Publication
(10) Pub. No.: US 2004/0255305 A1
(43) Pub. Date: Dec. 16, 2004

(54) Method of forming a pattern of sub-micron broad features

(76) Inventors: Egidius Gerardus Petrus Van Doren, Eindhoven (NL); Hendrikus Christianus Wilhemus Van Heesch, Eindhoven (NL)

Correspondence Address: Philips Electronics North America Corporation, Corporate Patent Counsel, PO Box 3001, Briarcliff Manor, NY, 10510, US

(21) Appl. No.: 10/493,176

(22) PCT Filed: Sep. 25, 2002
(86) PCT No.: PCT/IB02/03985

(30) Foreign Application Priority Data
Oct. 19, 2001 (EP) 01203998.8

(51) Int. Cl. G06F 9/00

(52) U.S. Cl. 719/320

(57) ABSTRACT

A pattern of very fine features (18) can be produced by illuminating an inorganic negative tone resist layer (16), provided on an electroplating base layer (14), by a beam (EB), which is able to cure the resist to a cured pattern according to the pattern to be formed, removing the non-illuminated portions of the resist layer and electroplating a layer (20) between the cured portions (18) of the resist layer.

For systems such as Internet audio, digital TV, set-top boxes, and time-shift recording, data processing is used. The input data (from disk, Internet, satellite, etc.) is processed in several steps and finally rendered on a display or loudspeaker. The trend is that more and more of this data processing is done in software. The data processing in software is based on a graph of connected processing nodes. The nodes do the actual processing and when a packet is processed it is passed to the next node in the chain.

The processing chain has to be controlled. Initially it has to be created, and during runtime the components in the chain may need to be reconfigured due to interaction with the user or due to changes in the data stream. This control code is called the application.

The application translates input from the user/data stream to a command to set a parameter of a streaming component. The streaming component(s) perform data processing according to the settings given by the application. The runtime characteristics of the application and the streaming components are different and in general it holds that streaming components have more real-time constraints. As a result the application and the streaming components will run on different threads/processes/processors and a communication mechanism is needed for the interaction between the application and the streaming components.

Control issued by the application should not disturb the real-time characteristics of the streaming components (e.g. blocking them, or cause priority inversion). The standard solution is that the application and the streaming components are decoupled by an OS primitive, such as a queue, a Remote Procedure (all RPC), or a semaphore-protected shared variable. From now on the term decouple queue will be used to denote such a decoupling mechanism. The interaction is as follows:

The application writes into or reads from/to the decouple queue independently of the streaming task (e.g. using a different execution context).

The streaming component reads out the decouple queue at specific points in the processing of the streaming data. It is algorithm dependent at which points reconfigurations can be made. Typical examples are just before or after data communication, or at the start or end of the processing loop. It is therefore not useful (or in some cases even erroneous) to take the contents of the decouple queue into account before such a specific point is reached (i.e. directly when the control is issued by the application).

A major disadvantage of using a generic RPC mechanism to cross a processor boundary to control a streaming component is that an RPC task has to be activated to put a message in the decouple queue of the streaming component. Activating an RPC task (with a high priority to get a fast response) has the disadvantage that a streaming task may be pre-empted. As a result, the data and instruction caches of the processor are partially flushed. This degrades the performance of the streaming components, which are optimized for cache usage.

According to the invention, the streaming component is split into two parts:

1. A control part (top): This part runs in the execution context of the application.

2. A streaming part (bottom): This runs in the execution context of the streaming process.

Although both parts are separated, they are both specific for each streaming component. This separation makes it possible to use a communication channel that is shared over processes/processors that is more efficient than the use of a standard RPC mechanism. From the functional perspective of the application, it looks as if the streaming component runs in the same execution context as the application (like it is the case for proxies in RPC).

These and other aspects of the invention will be apparent from and elucidated with reference to the embodiments shown in the drawings, in which:

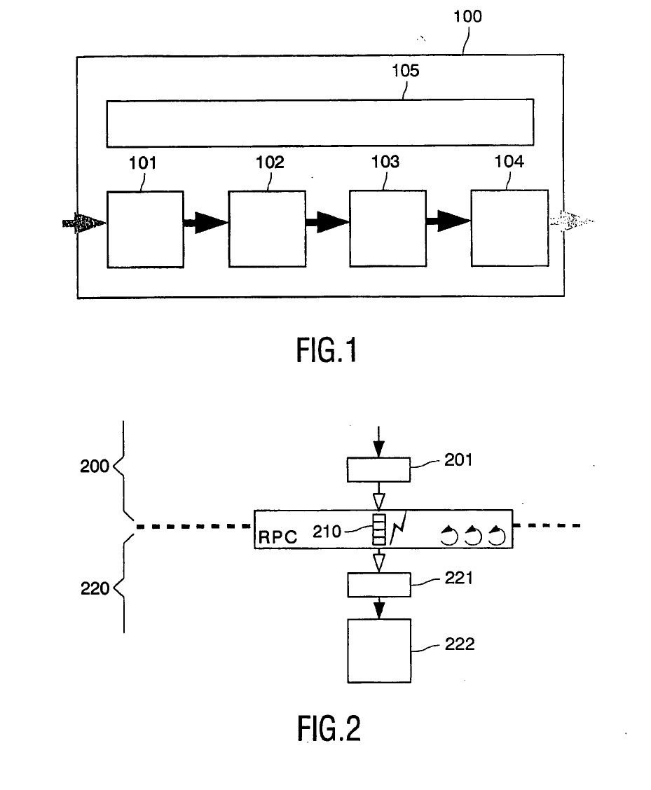

FIG. 1 schematically shows an example data processing system arranged for processing streaming music data in the MP3 format;

FIG. 2 illustrates the basic mechanism for Remote Procedure Calls (RPC);

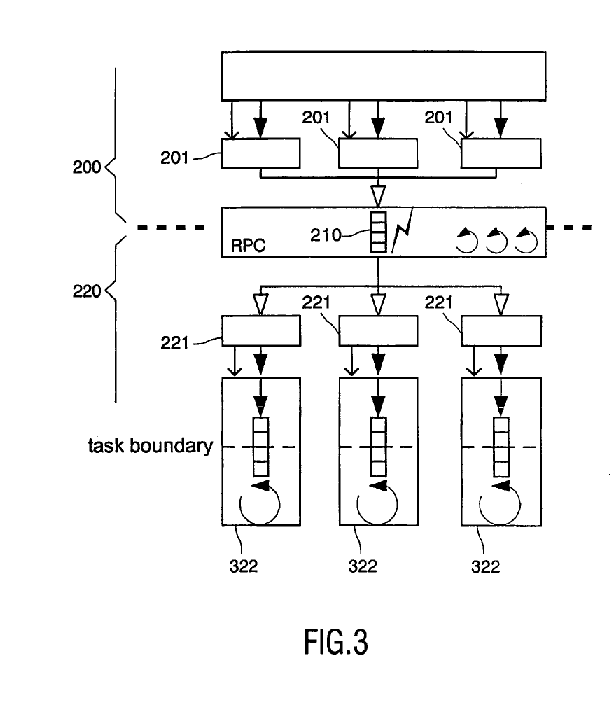

FIG. 3 illustrates an RPC mechanism being used for controlling streaming components;

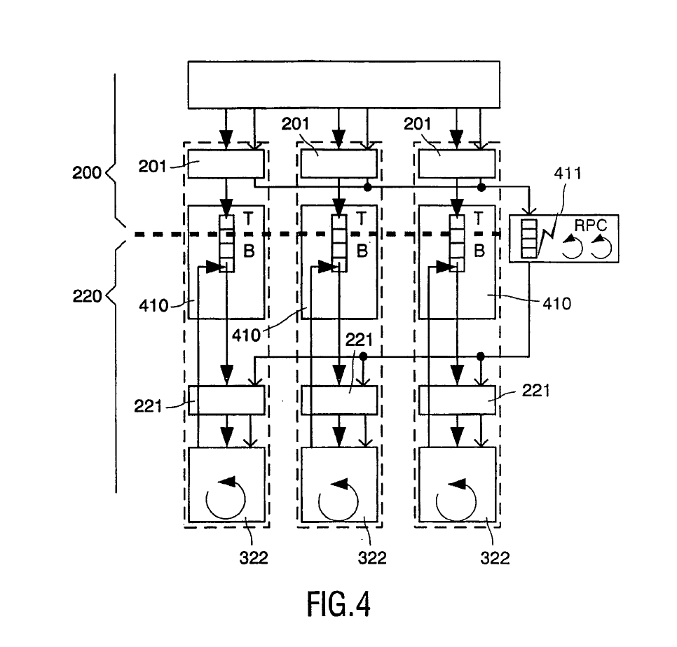

FIG. 4 shows how control can be done more efficiently by using a private communication channel for each component in addition to the mechanism of FIG. 2;

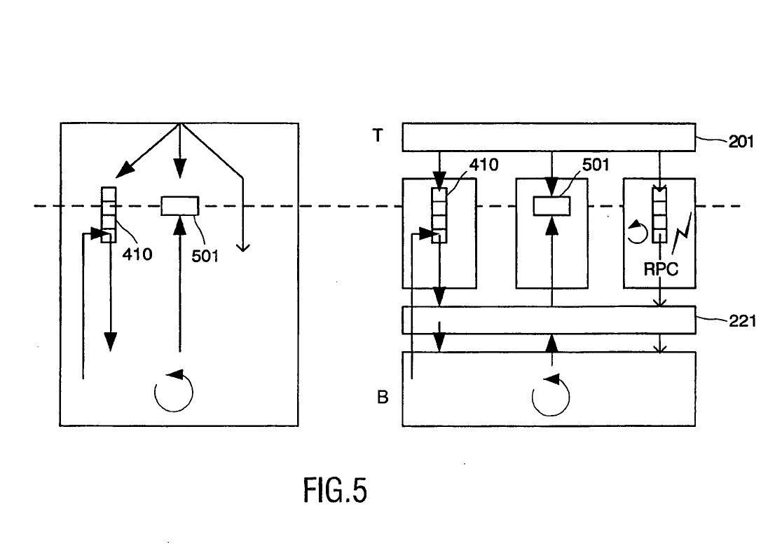

FIG. 5 depicts the difference between a “traditional” streaming component and a streaming component operating in accordance with the invention; and

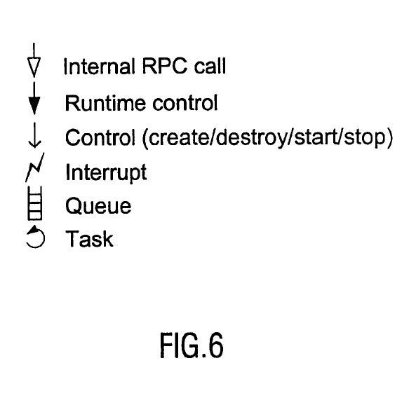

FIG. 6 provides a legend for symbols used in FIGS. 2, 3, 4 and 5.

Throughout the Figures, same reference numerals indicate similar or corresponding features. Some of the features indicated in the drawing are typically implemented in software, and as such represent software entities, such as software modules or objects.

FIG. 1 schematically shows an example data processing system 100 arranged for processing streaming music data. An input component 101 receives streaming data, which is in the well-known MP3 format (U.S. Pat. No. 5,579,430). An MP3 decoding component 102 decodes this streaming data to obtain music data, and feeds this to an equalizer component 103. After equalizing, the data is fed to an output component 104, which renders it, e.g. by playing the music data on a loudspeaker. Of course music data in other formats, video data in any format or any other data could easily be substituted for MP3 music. The streaming components 101-104 perform their data processing according to settings or parameters given by an application 105, which may change due to interaction with the user or due to changes in the data stream.

The runtime characteristics of the application 105 and the streaming components 101-104 are different and in general it holds that streaming components have more real-time constraints. As a result the application 105 and the streaming components 101-104 will run on different threads/processes/processors and a communication mechanism is needed for the interaction between the application 105 and the streaming components 101-104.

FIG. 2 illustrates the basic mechanism for Remote Procedure Calls (RPC). RPCs normally handle calling functions in another process/processor. In general an RPC-call has the following stages:

1. A client 200 calls a proxy 201 (a local representative for a remote service).

2. The proxy 201 marshals (packs) the arguments in a packet along with the function/method ID, and then adds the packet to a communication channel, such as a queue 210.

3. The communication channel 202 transfers the marshaled data to the other process 220 or processor (the server).

4. In the other process 220, a stub 221 is notified of new packets and (unpacks) the arguments and function/method ID.

5. The stub 221 calls the actual function 222 of the service with the unmarshaled arguments.

6. The method executes and returns its return value and arguments to the stub 221.

7. The stub 221 marshals the return arguments and puts a return packet in the communication channel 210.

8. The communication channel 210 transfers the packet to the client process/processor 200.

9. The proxy 201 is notified and unmarshals the return value and arguments.

10. Return value and arguments are returned to the original caller (the client).

In FIG. 2, the processes 200, 210 that communicate via RPC are shown as separated by a processor boundary, indicated with a dashed line. This boundary indicates that communication takes place from one processor to another. The two processors 200, 210 might be in two entirely different computer systems, connected via a network, but might also be in one single computer system. The processor boundary could also be virtual; a single processor could switch between the tasks for the client and for the server.

The RPC mechanism has a pool with one or more tasks that are used to call the functions on the remote processor via the stub. The proxy is a local representation of the remote functions. For the caller it looks like the functions are local (thus providing location transparency).

The streaming system of FIG. 1 could use RPC to allow communication between application 105 and streaming components 101-104. For example, suppose that due to a user event the settings of the equalizer changes. As a result the application code 105 calls a control function of the equalizer component 103, for instance SetBassLevel (float₁₃ level). For the component there is a local proxy providing this function. The proxy marshals the function ID and the function argument level into a packet and sends that to the streaming processor on which the equalizer component 103 runs.

On the streaming processor an interrupt awakens a worker task of the RPC mechanism, which fetches the packet from the communication channel, unmarshals it and calls the SetBassLevel function of the actual component. The equalizer component implements the SetBassLevel function by putting a message in its decouple queue. Just before the equalizer component fetches more audio data it checks the command queue, finds a pending message and calls the corresponding handler. This handler sets the new bass level, after which the audio streaming is processed using the new equalizer settings.

When a generic RPC mechanism is used for controlling streaming components, the situation as shown in FIG. 3 occurs. After a control command is marshaled and put in the command queue 210, an interrupt is generated on the streaming processor, which triggers an ISR (Interrupt Service Routine). The routine activates a task of the RPC for handling the function call. The function of the actual streaming component 322 is called which puts a message in the decouple queue. The streaming component 322 checks at certain points in its algorithm whether there is a message, and if so, it is executed.

A major disadvantage of using a generic RPC mechanism with streaming is that an RPC task has to be activated to put a message in the decouple queue of the streaming component 322. Activating an RPC task (with a high priority to get a fast response) has the disadvantage that a streaming task is pre-empted. As a result, the data and instruction caches are partially flushed. This degrades the performance of the streaming components, which are optimized for cache usage.

FIG. 4 shows two communication channels: a command queue 410 and a conventional RPC mechanism 411 that are both used for control. A shared variable or other mechanism could also be used as communication channel. The command queue mechanism 410 is used for runtime control and reduces the number of context-switches and interruptions on the streaming processor, which makes things more efficient. The RPC mechanism 411 is an active channel, i.e. it initiates communication by itself. The command queue 410 is a passive channel, i.e. it requires activity of the streaming component task to check it and can therefore only be used when the streaming component is running. Creating, destroying, starting, and stopping a streaming component still requires an active communication channel like the conventional RPC mechanism. Fortunately, these commands typically occur with a very low frequency.

In the present invention the streaming component is split into two parts:

1. A control part T (top): This part runs in the execution context of the application.

2. A streaming part B (bottom): This runs in the execution context of the streaming algorithm.

Although both parts are separated, they are both specific for each streaming component. This separation makes it possible to use a communication channel that is shared over processes/processors that is more efficient than a standard RPC mechanism. From the functional perspective of the application, it looks as if the streaming component runs in the same execution context as the application (like was the case for proxies in RPC).

Consider again the streaming system of FIG. 1. If the settings of the equalizer component 103 change as mentioned before, the application code 105 calls the SetBassLevel (float_level) function of the component 103. For the component 103 there is a local part (the top) providing this function. The top part T marshals the function ID and the function argument level into a message and sends that directly to the command queue 410 of the streaming component 322 whose bottom part B runs on the streaming processor. Just before the streaming component 322 fetches more audio data it checks the command queue 410, finds a pending message and calls the corresponding handler. This handler sets the new bass level, after which the audio streaming is processed using the new equalizer settings.

The difference between a “traditional” streaming component and the new situation for a component is depicted in FIG. 5. The communication mechanisms are factored out and the implementation can be instantiated depending on the situation. Examples:

The RPC mechanism can be reduced to an ordinary function call in the case that the application and streaming component are in the same process.

A shared variable 501 (e.g. a register) can be used.

The command queue can simply be implemented by a decouple queue in case that the application and streaming are on the same processor (but in different threads or processes). In the case that the command queue crosses a processor boundary the command queue could implemented using shared memory.

The use of passive communication channels for controlling streaming components in a multi process/processor system has at least the following advantages:

1. The application thread can immediately write into the passive communication channel independently of whether the control and streaming part are separated by thread/process/processor boundary.

2. No thread has to be activated in the streaming context to handle the control. The streaming algorithm runs independently and checks at its own defined points whether control is present. So in case of a multiprocessor system this prevents the need to interrupt the streaming processor, which would hurt performance.

3. The response on control is faster since no intermediate RPC task is needed.

4. In the traditional approach it is difficult to assign the right priorities to the RPC tasks in the task pool. In the proposed approach, the runtime commands are automatically handled on the same priority as the streaming component (ideal situation).

5. Code on a Very Long Instruction Word (VLIW) processor (sometimes used as streaming processor, such as the Philips TriMedia IC) is more expensive in text size than a standard RISC processor (often used as control processor, such as MIPS or ARM chips). By moving the code of the control part of the component from such streaming processor to such a control processor, the text size reduces.

6. Execution of control code (lot of branches) executes less efficient on a VLIW than on a RISC processor, since a VLIW cannot exploit instruction level parallelism for such code. By moving the code of the control part of the component from such streaming processor to such a control processor, the relative performance increases.

7. Subsystems consisting of multiple streaming components have a similar separation between control and streaming. The control code, which is the main added value of a subsystem, runs on the control processor. So the advantages of code text size and relative execution performance also hold for subsystems.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer.

In the system claim enumerating several components, several of these components can be embodied by one and the same item of hardware. The mere fact that certain measures are recited in mutually different dependent claims does not indicate that a combination of these measures cannot be used to advantage.

1. A communication method between a control component and a streaming component, the streaming component having a passive interface for polling whether control commands are pending, which interface is polled at those points in time at which it makes sense to execute a control command.

2. The method of claim 1, in which the interface is polled just before the streaming component fetches data.

3. The method of claim 1, in which the passive interface comprises a command queue.

4. The method of claim 3, in which the passive interface comprises a decouple queue.

5. The method of claim 1, in which the passive interface comprises a shared variable.

6. The method of claim 1, in which the streaming component comprises a control part running in a first execution context, and a streaming part running in a second execution context.

7. The method of claim 6, in which the first execution context is the context of the control component.

8. A computer system arranged for streaming data transmission, comprising a control component and a streaming component, the streaming component having a passive interface for polling whether control commands are pending, which interface is polled at those points in time at which it makes sense to execute a control command.

9. The computer system of claim 8, wherein the control component is a software module.

10. The computer system of claim 8, wherein the streaming component is a software module.

11. The system of claim 8, in which the interface is polled just before the streaming component fetches data.

12. The system of claim 8, in which the streaming component comprises a control part running in a first execution context, and a streaming part running in a second execution context.
